(19) United States
(12) Patent Application Publication
(10) Pub. No.: US 2005/0246867 A1
(43) Pub. Date: Nov. 10, 2005

(54) Tightening band, and tightening band producing method

(75) Inventor: Kentaro Nagata, Hyogo (JP)

Correspondence Address: Attention: PATENTS;COWAN, LIEBOWITZ & LATMAN, P.C., 1133 AVENUE OF THE AMERICAS, NEW YORK, NY, 10036, US

(73) Assignee: Kentaro NAGATA, Itami-shi (JP)

(21) Appl. No.: 10/521,004

(22) PCT Filed: Jul. 9, 2003
(86) PCT No.: PCT/JP03/08706

§ 371 Date: Jan. 7, 2005

(30) Foreign Application Priority Data
Jul. 11, 2002 (JP) 2002-203185

(51) Int. Cl. F16L 33/00

(52) U.S. Cl. 24/20 R

(57) ABSTRACT

A tightening band used for fixing, for example, a cover for protecting a joint of a rotary shaft of an automobile, and a method for producing the same. The tightening band realizes an improved workability of attachment, a proper tightening strength, a wider applicable range of members to be tightened, and a stable tightening strength lasting for a long time. In the tightening band, a pattern of projections and depressions is formed on the surface of each component. Preferably, the pattern is formed by providing depressions, each having a depth of 2 μm to 30 μm, on the surface of a band main body, a lever plate, and a lever-plate fixing member.

### TECHNICAL FIELD

The present invention relates to a tightening band used for fixing, for example, a cover for protecting a joint of a rotary shaft to the joint in an automobile, and a method for producing the same.

### BACKGROUND ART

A cover for protecting a joint of a rotary shaft of an automobile is generally called a “boot”. The boot is used at many parts, for example, at a joint of a drive shaft for transferring the torque of a differential gear to wheels (the joint between a rotary shaft on the differential gear side and a rotary shaft on the wheel-attached side) and at a joint for transferring the torque of a handle to a wheel steering shaft. In an automobile, boots are provided at no less than 30 parts.

This type of boot typically has a pleated periphery as shown in FIG. 6 and the cross section thereof is circular defining a hollow. In this boot 1, a tightening band for fixing the boot (hereinafter referred to as a “boot fixing band”), which is not shown in FIG. 6, is attached around each of an outer periphery 1a at the large-diameter end and an outer periphery 1b at the small-diameter end. By tightening these boot fixing bands, the boot is fixed to a rotary shaft or the like.

The boot 1 rotates in conjunction with a rotary shaft. Particularly, the boot used at an axle rotates at high speed with the axle, and thus the boot must be securely fixed to the axle.

Therefore, the boot fixing band should be easy to attach and is required to be highly reliable in the tightening ability enabling secure tightening and the endurance against long use under severe working conditions. In order to satisfy such requirements for high reliability, various improvements have been made and put into practical use.

As an example of the improvements, a boot fixing band disclosed in Japanese Patent Application Laid-open No. Hei 10-26107 is described below (hereinafter referred to as a “known boot fixing band”). FIG. 7 shows the known boot fixing band. This boot fixing band 2 includes a band main body 20, which includes a ring portion 21 formed by bending a metallic elongated band plate; and a band protrusion 22 formed by overlapping a predetermined length of both end portions of the metallic elongated band plate such that the both end portions face each other. Also, the boot fixing band 2 includes an arc-shaped lever plate 23, which is fixed to the band protrusion 22 of the band main body 20 and which applies a tightening force based on leverage in order to tighten the boot 1 shown in FIG. 6; and a lever-plate fixing member 24 for fixing a top portion 23a of the lever plate 23 by two projected portions 24a and 24b when the lever plate 23 is laid on the band main body 20.

Each of the band main body 20, the lever plate 23, and the lever-plate fixing member 24 comprises stainless material. The plate thickness is 0.3 mm to 0.8 mm in the band main body 20 and the lever-plate fixing member 24, but the lever plate 23 is thicker about twice.

The top portion 23a of the lever plate 23 is protruded outward from a top portion 22a of the band protrusion 22, and the lever plate 23 is fixed to the vicinity of the top portion 22a of the band protrusion 22 (a portion indicated by a dotted-line circle, hereinafter referred to as a “welded portion 22c”) by spot welding using electric resistance, such that an end portion 23b thereof is in contact with an outer periphery 21a of the ring portion 21 of the band main body 20.

In this structure, the lever plate 23 is fixed to the band protrusion 22 such that the welded portion 22c of the band protrusion 22 is positioned near the center in the longitudinal direction of the outer surface of the arc-shaped lever plate 23 and that the end portion 23b of the lever plate 23 is in contact with the outer periphery 21a of the ring portion 21 of the band main body 20.

After the components have been positioned in that manner, the lever plate 23 is spot-welded to the band protrusion 22. Accordingly, at the spot-welded portion 22c, the two plate portions forming the band protrusion 22 (both end portions of the metallic elongated band plate facing each other) and the lever plate 23: three layers in total, are welded together.

In this way, when the lever plate 23 and the band protrusion 22 are fixed to each other at the welded portion 22c, the top portion 23a of the lever plate 23 is protruded outward from the top portion 22a of the band protrusion 22 and the end portion 23b thereof is in contact with the outer periphery 21a of the ring portion 21 of the band main body 20. Additionally, the space between the end portion 23b of the lever plate 23 and a root portion 22b of the band protrusion 22 need be optimally set.

In the boot fixing band 2 having the above-described structure, by tilting the lever plate 23 in the direction of the arrow Y1 until the inner surface (inner side of the arc) of the lever plate 23 contacts the outer periphery 21a of the ring portion 21 of the band main body 20, with the end portion 23b of the lever plate 23 serving as the fulcrum, the boot fixing band 2 becomes deformed while the diameter of the ring portion 21 of the band main body 20 being reduced, thereby applying a tightening force to the boot 1.

The boot fixing band 2 is provided on each of both ends of the boot 1. That is, two boot fixing bands 2 are prepared: one is for the outer periphery 1a at the large-diameter end and the other is for the outer periphery 1b at the small-diameter end of the boot 1. The two boot fixing bands 2 have the same shape and the same components, although they are different in dimension, such as the diameter of the ring portion 21 of the band main body 20. Hereinafter, both are regarded as being the same unless it is necessary to distinguish between them.

On the other hand, the lever-plate fixing member 24 is also fixed to the band main body 20 by spot welding or the like. When the lever plate 23 is tilted in the direction of the arrow Y1 so as to be laid along the outer periphery 21a of the ring portion 21 of the band main body 20, the two projected portions 24a and 24b of the lever-plate fixing member 24 are folded inwardly, so that the lever plate 23 is fixed to the ring portion 21 of the band main body 20.

When the boot fixing band 2 having the above-described structure is used for tightening the boot 1, the lever plate 23 of the boot fixing band 2 is made upright as a first step (the angle between the lever plate 23 and the ring portion 21 of the band main body 20 is approximately 90 degrees). Alternatively, the lever plate 23 may be kept extended linearly from the band main body 20 instead of making it upright. Then, the ring portion 21 of the band main body 20 is attached around each of the outer periphery 1a at the large-diameter end and the outer periphery 1b at the small-diameter end of the boot 1 shown in FIG. 6. Herein, a case where the large-diameter end of the boot 1 is tightened is described.

Assuming that the ring portion 21 of the band main body 20 of the boot fixing band 2 is attached around the outer periphery 1a at the large-diameter end of the boot 1, the operation of the boot fixing band 2 in that state will be described with reference to (A) and (B) of FIG. 8. In (A) and (B) of FIG. 8, part of the boot fixing band 2 that is required for describing a tightening operation is shown, and thus the boot 1 is not shown.

Referring to (A) of FIG. 8, the lever plate 23 is tilted in the direction of the arrow Y1, with the end portion 23b being the fulcrum. At this time, the end portion 23b is in contact with the outer periphery 21a of the ring portion 21 of the band main body 20.

With this operation, the end portion 23b of the lever plate 23 moves in the direction of the arrow Y2 while applying a pressing force to the ring portion 21 of the band main body 20. At this time, a tensile force toward the top portion 23a of the lever plate 23 is applied to the band protrusion 22 in accordance with the tilting operation of the lever plate 23 in the direction of the arrow Y1. Further, the pressing force of the end portion 23b of the lever plate 23 applied to the outer periphery 21a of the ring portion 21 deforms the ring portion 21 and the band protrusion 22 as shown in (B) of FIG. 8. Accordingly, the diameter of the ring portion 21 becomes smaller, so that the band main body 20 applies a tightening force to the entire outer periphery 1a at the large-diameter end of the boot 1.

This tightening operation using the lever plate 23 is continued until the top portion 23a of the lever plate 23 is brought into contact with the outer periphery 21a of the ring portion 21 of the band main body 20. After the vicinity of the top potion 23a of the lever plate 23 has been brought into contact with the outer periphery 21a of the ring portion 21, the projected portions 24a and 24b of the lever-plate fixing member 24 (see FIG. 7) are folded inwardly so as to hold the lever plate 23. As a result, the lever plate 23 is fixed along the ring portion 21 of the band main body 20.

In the conventionally used boot fixing band 2, a tightening operation can be easily performed while realizing secure tightening. Furthermore, external protrusions in the final state after the tightening operation are small. Therefore, the boot fixing band 2 is suitably used at a portion of high-speed rotation, such as an axle. Also, a tightening band with no lever-plate portion disclosed in Japanese Patent Application Laid-open No. Hei 11-218282 has been adopted for the same reason. In this way, the tightening band, which includes a band main body including a ring portion formed by bending a metallic elongated band plate and a protrusion formed by overlapping a predetermined length of both end portions of the metallic elongated band plate and which applies a tightening force to a member to be tightened, such as the boot 1, by reducing the diameter of the ring portion of the band main body, has been used in various fields.

Various tightening bands for fixing a boot or the like of an automobile, including the boot fixing band 2 shown in FIG. 7 and the tightening band with no lever-plate portion disclosed in Japanese Patent Application Laid-open No. Hei 11-218282, are strongly required to have a reliable tightening effect and endurance against long use under severe working conditions.

Therefore, in the boot fixing band 2 shown in FIG. 7, the lever plate 23 must be kept fixed to the band protrusion 22 for a long time, and also the lever-plate fixing member 24 must be kept fixed to the band main body 20 for a long time. In other words, the welding between the lever plate 23 and the band protrusion 22 and between the lever-plate fixing member 24 and the band main body 20 must be reliably performed. Also, in the tightening band with no lever-plate portion disclosed in Japanese Patent Application Laid-open No. Hei 11-218282, the same reliability is required in a welded portion.

As described above, the lever plate 23 is fixed to the band protrusion 22 and the lever-plate fixing member 24 is fixed to the band main body 20 by spot welding using electric resistance. In particular, during a tightening operation, the lever plate 23 must be strongly pressed in the direction of the arrow Y1 as described above, and thus a heavy load is applied to the welded portion 22c. Therefore, it is an extremely important object to maintain the reliability in the welding strength between the lever plate 23 and the band protrusion 22.

In general spot welding, members are welded while being in contact with each other at one point, and thus a sufficient welding strength may not be obtained. That is, as shown in FIG. 9, spot welding is performed by disposing a pair of opposed electrodes 10a and 10b on the members to be welded (in the example in FIG. 9, the lever plate 23 and the band protrusion 22), respectively, and applying current I across the electrodes 10a and 10b. However, a sufficient welding strength may not be obtained due to nugget layers 11 generated by welding.

As can be seen in FIG. 9, the nugget layers 11 are generally generated so as to extend deeply in the plate thickness direction along the flowing direction of the current I, when the welded members are in contact with each other at one point. At this time, if the nugget layers 11 generated in the welded members extend to interfere with each other, the members may be disadvantageously perforated if the members are made of thin plates.

In the boot fixing band 2 shown in FIG. 7, the amount of tightening is set depending on the distance between the fulcrum of an operation of tilting the top portion 23a of the lever plate 23 in the direction of the arrow Y1 and the upper end of the top portion 22a of the band protrusion 22, that is, the distance L1 between the end portion 23b of the lever plate 23 and the upper end of the top portion 22a of the band protrusion 22. Therefore, in order to keep the amount of tightening constant, the distance L1 (see FIG. 8) between the end portion 23b of the lever plate 23 and the upper end of the top portion 22a must be kept at a constant value.

The distance L1 between the end portion 23b of the lever plate 23 and the upper end of the top portion 22a of the band protrusion 22 greatly depends on the overlapped area of the lever plate 23 and the band protrusion 22. However, the distance L1 essentially depends on the welded position of the lever plate 23 to the band protrusion 22. For this reason, the lever plate 23 must be welded to the band protrusion 22 after determining the welded position with great precision. However, this kind of boot fixing band 2 is generally mass-produced, and thus the productivity decreases if spot welding is performed after such strict positioning.

Also, in this boot fixing band 2 and the tightening band disclosed in Japanese Patent Application Laid-open No. Hei 11-218282, the surface thereof is generally mirror-finished and slippery, which causes a problem of poor workability when a tightening operation is performed by using the lever plate 23 and so on. Further, the boot 1 tightened by the boot fixing band 2 or the like varies according to automobile manufacturers and car models. Accordingly, the diameter of the ring portion 21 or the shape of the lever plate 23 of the boot fixing band 2 slightly varies in many cases. However, since these tightening bands look similar, it is very confusing to manage the tightening bands, such as the boot fixing band 2, according to each automobile manufacturer or each car model.

The present invention has been made to solve the above-described problems, and an object of the present invention is to provide a tightening band which realizes higher reliability of spot welding, a proper tightening strength, an improved workability of attachment, a wider applicable range of members to be tightened, and a stable tightening strength lasting for a long time without requiring strict management, and a method for producing the same. Another object of the present invention is to provide a tightening band which realizes an improved workability of attachment, a proper tightening strength, a wider applicable range of members to be tightened, and a stable tightening strength lasting for a long time, and a method for producing the same.

### DISCLOSURE OF THE INVENTION

In order to achieve the above-described objects, a tightening band of the present invention includes: a band main body including a ring portion formed by bending a metallic elongated band plate and a band protrusion formed by overlapping and welding a predetermined length of both end portions of the metallic elongated band plate such that the both end portions face each other; a lever plate whose top side is protruded outward from the top of the band protrusion and which is fixed to the band protrusion by being welded thereto such that the end side of the lever plate is in contact with the outer periphery of the ring portion of the band main body; and a lever-plate fixing member which is fixed to the band main body by being welded thereto so as to fix the top portion of the lever plate to the band main body. The diameter of the ring portion of the band main body is reduced by tilting the lever plate until the surface of the lever plate is brought into contact with the outer periphery of the ring portion of the band main body while the end side of the lever plate serving as the fulcrum, so as to apply a tightening force to a member to be tightened. A pattern of projections and depressions is formed on the surface of each of the band main body, the lever plate, and the lever-plate fixing member.

In the present invention, by forming a pattern on the surface of the tightening band, in particular, on the band main body, the surface area of the band main body increases, the yield strength improves, and the range of extension and contraction widens, so that the allowable range of the amount of tightening widens. Accordingly, the applicable range of the diameter of a member to be tightened by the tightening band can be widened. That is, one type of tightening band can be used for a plurality of types of boots whose diameters at an attached portion slightly differ from each other.

Further, the improved yield strength and the wider range of extension and contraction widen the allowable range of the amount of tightening. Accordingly, an error of the fulcrum position of the lever plate can be absorbed, the allowable range of the precision of positioning performed before the lever plate is welded to the band protrusion can be widened, and thus the productivity can be improved.

Since the pattern is formed in the inner periphery of the band main body, the frictional resistance can be increased. Accordingly, after a member has been tightened by the tightening band, the tightening band resists moving on the tightened surface of the tightened member, so that a stable tightening strength can be maintained for a long time under severe working conditions. In particular, remarkable effects can be obtained when the member to be tightened is a boot used at a joint of a rotary shaft or the like of an automobile.

Further, by forming a pattern on the surface of the tightening band, members to be welded can contact each other at many points when spot welding or the like is performed. Accordingly, the welding strength can be enhanced and the reliability of welding can be increased.

A tightening band of another invention includes: a band main body including a ring portion formed by bending a metallic elongated band plate and a band protrusion formed by overlapping a predetermined length of both end portions of the metallic elongated band plate such that the both end portions face each other; a lever plate whose top side is protruded outward from the top of the band protrusion and which is fixed to the band protrusion such that the end side of the lever plate is in contact with the outer periphery of the ring portion of the band main body; and a lever-plate fixing member for fixing the top portion of the lever plate to the band main body. The diameter of the ring portion of the band main body is reduced by tilting the lever plate until the surface of the lever plate is brought into contact with the outer periphery of the ring portion of the band main body while the end side of the lever plate serving as the fulcrum, so as to apply a tightening force to a member to be tightened. A pattern of projections and depressions is formed on at least the inner periphery of the band main body and the surface of the lever plate which contacts the band main body.

In this way, by forming a pattern on the inner periphery of the band main body of the tightening band, slip on the tightened member can be prevented and the workability can be improved. Further, by forming a pattern, the range of extension and contraction widens, a proper tightening strength can be easily obtained, and the applicable range of the diameter of a member to be tightened by the tightening band can be widened. That is, one type of tightening band can be used for a plurality of types of boots whose diameters at an attached portion slightly differ from each other.

Since the pattern of projections and depressions is formed on the surface of the lever plate which contacts the band main body, portions to be welded can contact each other at many points when the lever plate is welded. Accordingly, the welding strength can be enhanced and the reliability of welding can be increased.

A tightening band of another invention includes a band main body including a ring portion formed by bending a metallic elongated band plate, a predetermined length of both end portions of the metallic elongated band plate being overlapped. The diameter of the ring portion of the band main body is reduced so as to apply a tightening force to a member to be tightened. A pattern of projections and depressions is formed on at least the inner periphery of the band main body.

In this way, by forming a pattern on the inner periphery of the band main body of the tightening band, slip on the tightened member can be prevented and the workability can be improved. Further, by forming a pattern, the range of extension and contraction widens, a proper tightening strength can be easily obtained, and the applicable range of the diameter of a member to be tightened by the tightening band can be widened. That is, one type of tightening band can be used for a plurality of types of boots whose diameters at an attached portion slightly differ from each other. Further, since the pattern is formed on the inner periphery of the band main body, the frictional resistance can be increased. Accordingly, after a member has been tightened by the tightening band, the tightening band resists moving on the tightened surface of the tightened member, so that a stable tightening strength can be maintained for a long time under severe working conditions. In particular, remarkable effects can be obtained when the member to be tightened is a boot used at a joint of a rotary shaft or the like of an automobile.

Preferably, when fixing for forming the band protrusion, fixing between the band protrusion and the lever plate, or fixing between the band main body and the lever-plate fixing member is performed by welding, the pattern of projections and depressions is formed at least so that each member to be welded contacts each other at many points inside the diameter of a spot to be welded. With this structure, nugget layers generated in the welded member can be made flat and interference between the nugget layers can be prevented. Accordingly, disadvantages such as perforation can be prevented and the reliability of welding can be increased.

The pattern of projections and depressions is preferably formed by providing a plurality of linear depressions in a mesh pattern on the surface. With this structure, the thickness of the plate does not exceed the original thickness after forming the pattern of projections and depressions, and the weight can be reduced.

The depth of each depression is preferably 2 μm to 30 μm. By setting the depth of the pattern formed on the surface of the tightening band in the range of 2 μm to 30 μm, the tightening band can suit with various conditions, such as difference in the material of members to be tightened and use conditions of members to be tightened.

The pattern formed on the surface preferably includes a plurality of types of patterns, and each type of pattern represents identification information of a boot fixing band on which the pattern of the type is formed. With this structure, tightening bands can be managed by types of pattern. For example, if the tightening band is for fixing a boot of an automobile, the pattern may be changed for each automobile manufacturer or each car model. Also, the pattern may be changed for each used part in an automobile. Accordingly, the tightening bands which apparently look similar can be easily managed.

The pattern formed on the surface preferably includes a plurality of types of patterns in one tightening band. By forming a plurality of types of patterns in one tightening band, the range of the yield strength of the tightening band can be varied.

Preferably, the member to be tightened is a protective cover for protecting a joint of a rotary shaft of an automobile. By using a protective cover for protecting a joint of a rotary shaft of an automobile as the member to be tightened, the tightening band of the present invention exerts its effect remarkably in terms of tightening workability and endurance under severe working conditions.

In a method for producing a tightening band of another invention, a tightening band which includes a band main body including a ring portion formed by bending a metallic elongated band plate and a band protrusion formed by overlapping and fixing by welding a predetermined length of both end portions of the metallic elongated band plate such that the both end portions face each other; a lever plate whose top side is protruded outward from the top of the band protrusion and which is fixed to the band protrusion by being welded thereto at the same time when the band protrusion is formed such that the end side of the lever plate is in contact with the outer periphery of the ring portion of the band main body; and a lever-plate fixing member for fixing the top portion of the lever plate to the band main body by welding, is produced. The diameter of the ring portion of the band main body is reduced by tilting the lever plate until the surface of the lever plate is brought into contact with the outer periphery of the ring portion of the band main body while the end side of the lever plate serving as the fulcrum, so as to apply a tightening force to a member to be tightened. The method includes: forming a pattern of projections and depressions, the difference between the projections and depressions being 2 μm to 30 μm, on reduction rolls used in at least one of rolling steps of rolling each metallic plate as a base material of the band main body, the lever plate, and the lever-plate fixing member; forming the pattern of projections and depressions having a depth of 2 μm to 30 μm on at least one of the surfaces of the metallic plate by passing the metallic plate through the reduction rolls; and cutting the rolled base material into plates for the band main body, the lever plate, and the lever-plate fixing member, so as to produce the tightening band by using the cut plates with the pattern for the band main body, the lever plate, and the lever-plate fixing member.

In this way, by forming a pattern in at least one of the rolling steps during a process of producing each component of the tightening band, a desired pattern can be easily formed, and a process of producing a tightening band can be performed in a conventional manner thereafter. Therefore, the present invention can be realized without a large amount of capital investment nor a significant change of producing process.

In a method for producing a tightening band of the present invention, a tightening band which includes a band main body including a ring portion formed by bending a metallic elongated band plate, a predetermined length of both end portions of the metallic elongated band plate being overlapped, is produced. The diameter of the ring portion of the band main body is reduced so as to apply a tightening force to a member to be tightened. The method includes: forming a pattern of projections and depressions, the difference between the projections and depressions being 2 μm to 30 μm, on reduction rolls used in at least one of rolling steps of rolling a metallic plate as a base material of the band main body; forming the pattern of projections and depressions having a depth of 2 μm to 30 μm on at least one of the surfaces of the metallic plate by passing the metallic plate through the reduction rolls; cutting the rolled base material into a plate for the band main body, and bending the cut plate with the pattern for the band main body into a ring shape so that the pattern is placed on the inner periphery thereof, so as to form the band main body.

In this way, by forming a pattern in at least one of the rolling steps during a process of producing the band main body of the tightening band, a desired pattern can be easily formed. The plate may be bent after the rolling step so that the pattern is placed on the inner periphery, and thus a process of producing a tightening band can be performed in a conventional manner. Therefore, the present invention can be realized without a large amount of capital investment nor a significant change of producing process.

Preferably, the reduction rolls include a plurality of types of reduction rolls so that the pattern differs from one reduction roll to another, and any reduction rolls can be arbitrarily selected from among the reduction rolls and used in the rolling step. By adopting this producing method, various patterns can be formed only by changing the reduction rolls. For example, if the tightening band is for fixing a boot of an automobile, the pattern may be changed for each automobile manufacturer or each car model. Further, the pattern may be changed for each used part in an automobile.

### BRIEF DESCRIPTION OF THE DRAWINGS

FIG. 1 is a perspective view illustrating a tightening band according to an embodiment of the present invention.

FIG. 2 is an enlarged cross-sectional view taken along the line A-A in FIG. 1.

FIG. 3 illustrates a state where a band protrusion and a lever plate of the tightening band shown in FIG. 1 are spot-welded.

FIG. 4 illustrates a method for producing a tightening band according to an embodiment of the present invention, wherein a process of rolling a plate, which is part of a process of producing the tightening band, is shown.

FIG. 5 shows a modification of the tightening band shown in FIG. 1, wherein (A) is a partial perspective view thereof and (B) is a perspective view of a lever-plate fixing member.

FIG. 6 shows a boot as a component of an automobile, which is a member to be tightened by the tightening band of the present invention or a known art.

FIG. 7 is a perspective view showing a known tightening band.

FIG. 8 illustrates a tightening operation in the tightening band shown in FIG. 7, wherein (A) shows a lever plate and a band protrusion before the tightening operation and (B) shows the lever plate and the band protrusion during the tightening operation.

FIG. 9 illustrates a state where the band protrusion and the lever plate of the tightening band shown in FIG. 7 are spot-welded.

### BEST MODE FOR CARRYING OUT THE INVENTION

Hereinafter, an embodiment of the present invention will be described.

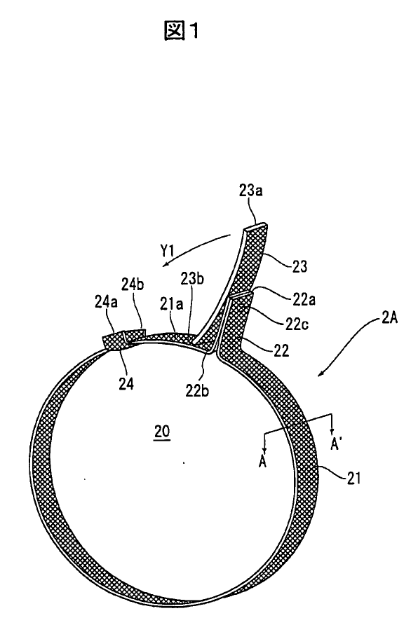

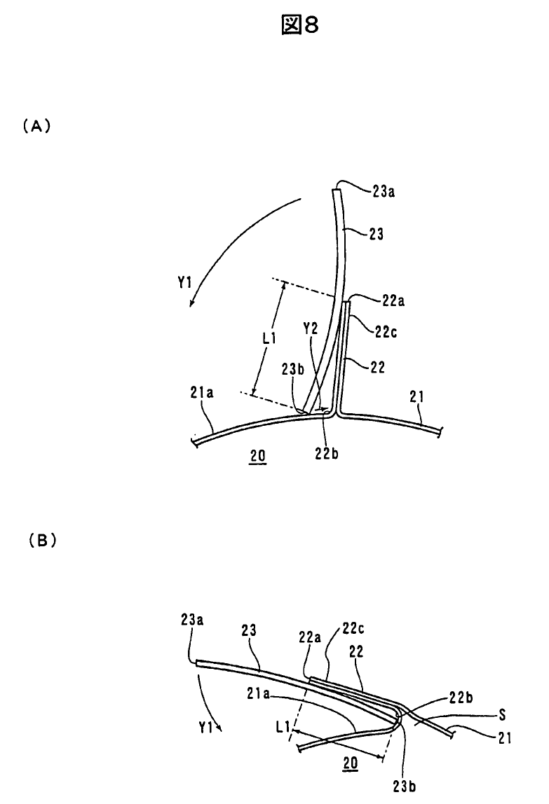

FIG. 1 shows a boot fixing band 2A, which is a tightening band of the present invention, according to the embodiment. The shape and components of the boot fixing band 2A of the embodiment are the same as those of the known boot fixing band 2 shown in FIG. 7, so the same parts are denoted by the same reference numerals and the corresponding description will be omitted or simplified.

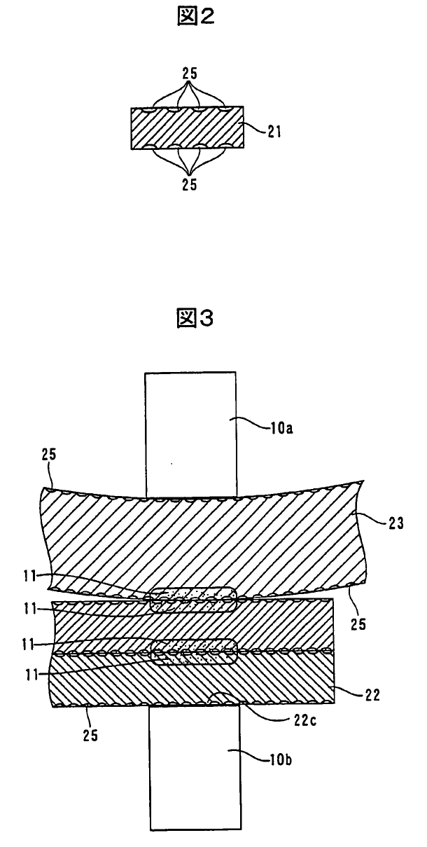

The boot fixing band 2A of the embodiment is different from the known boot fixing band in that a fine pattern 25 of projections and depressions (see FIG. 2) is formed on the surface (in this embodiment, both front and rear surfaces) of each component: the band main body 20 consisting of the ring portion 21 and the band protrusion 22; the lever plate 23; and the lever-plate fixing member 24.

The pattern 25 is formed by providing depressions on the surfaces of the band main body 20, the lever plate 23, and the lever-plate fixing member 24. The depth of each depression is 2 μm to 30 μm from the surface of each component. On the other hand, as shown in FIG. 5, the surface of the known boot fixing band 2 of this type is mirror-finished, and the surface roughness thereof, that is, the depth of depressions on the surface, is generally 0.5 μm or less. Compared to this, the depth of the pattern 25 of this embodiment is 2 μm to 30 μm, which is deeper by 4 to 60 times than that in the known boot fixing band. Accordingly, a surface of rough texture can be obtained.

The type of pattern 25 formed on the surface of each component is not specified to a predetermined type. For example, linear depressions may be provided in a regular grid pattern, or irregular curved pattern may be used. Alternatively, many circular or rectangular depressions may be regularly or randomly provided. In any case, the pattern 25 is formed of depressions as shown in FIG. 2, and the thickness of each plate at projections is the same as the original thickness of the plate in each of the band main body 20, the lever plate 23, and the lever-plate fixing member 24. FIG. 2 is a cross-sectional view taken along the line A-A′ of the ring portion 21 of the band main body 20 in FIG. 1.

The pattern 25 must be a fine pattern. Desirably, depressions should be formed so that welded members contact each other at many points (ideally at several tens of points) in the spot diameter (about 2.0 mm) of spot welding. A method for forming the pattern 25 will be described later.

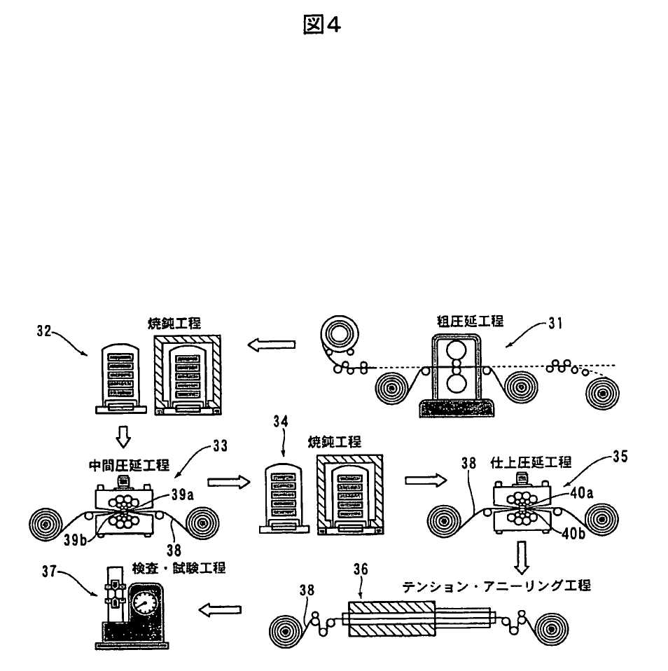

In this way, in the boot fixing band 2A, by forming the pattern 25 as shown in FIG. 1 on the front and rear surfaces of each component, the band protrusion 22 and the lever plate 23 contact each other at many points in the welded portion 22c when the lever plate 23 is spot-welded to the band protrusion 22, as shown in FIG. 3. This is the same for a case where the lever-plate fixing member 24 is spot-welded to the ring portion 21 of the band main body 20.

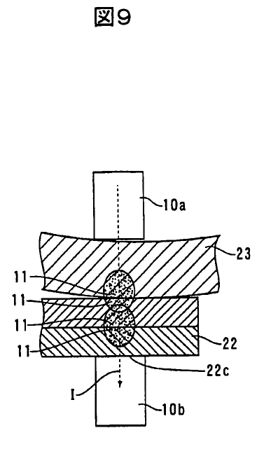

By performing spot welding in such a state of multipoint contact, members are welded at each contact point and the reliability of welding is significantly enhanced, so that defectives caused by welding failure can be significantly reduced. That is, by adopting the multipoint contact, the current applied across the electrodes 10a and 10b can be reduced. Accordingly, the nugget layers 11, which are generated by welding, are not locally generated at one point but are evenly generated at some points, unlike in the one-point contact in the known art (see FIG. 8). Therefore, the nugget layers 11 do not extend deeply in the plate thickness direction.

Accordingly, even when spot welding is performed on thin plates of 0.3 mm to 0.8 mm, such as the components of the boot fixing band 2A, each plate resists thermal deterioration, so that disadvantages including perforation can be prevented and the reliability of welding can be enhanced.

Further, by forming the pattern 25 as shown in FIG. 1 on the surface of each component of the boot fixing band 2A, allowance can be given to the positioning precision of the lever plate 23. That is, as described above, the distance L1 (see FIG. 8) between the end portion 23b of the lever plate 23 and the upper end of the top portion 22a of the band protrusion 22 need be adequately set. However, when each component of the boot fixing band 2A has the pattern 25 as shown in FIG. 1 as in the embodiment, so much precision is not required in the distance L1 between the end portion 23b of the lever plate 23 and the upper end of the top portion 22a of the band protrusion 22. No need for so much precision in the distance L1 means that the welded position between the lever plate 23 and the band protrusion 22 need not be strictly determined.

The reason why the welded position between the lever plate 23 and the band protrusion 22 need not be strictly determined by forming the pattern 25 is as follows.

By forming the pattern 25 on the surface of the boot fixing band 2A (particularly, the band main body 20), the surface area thereof increases, and the amount of extension and restoration increases correspondingly. In other words, the larger the surface area, the wider the range between the top dead center and the bottom dead center becomes until the yield point is reached. This means that the range of the yield strength becomes wider, that is, the yield strength is improved until the yield point is reached. Accordingly, the range of extension and contraction becomes wider, so that an error at the end portion 23b of the lever plate 23 can be absorbed.

For this reason, so much precision is not required in the positioning performed before the lever plate 23 is welded to the band protrusion 22. This means that the allowable range of the distance L1 between the end portion 23b of the lever plate 23 and the upper end of the band protrusion 22 is widened. Therefore, even if the distance L1 slightly varies, the variation is accommodated by the wide range of yield strength of the band main body 20.

As described above, since not so much precision is required in the positioning performed before the lever plate 23 is welded to the band protrusion 22, the workability can be significantly improved, and thus many types of bands can be advantageously produced in low volumes, let alone one type of bands can be mass-produced. Furthermore, defective tightening bands can be reduced, and tightening failure caused when a tightening band is attached is reduced due to the wider range of extension and contraction.

Further, the increased yield strength of the band main body 20 and the wider range of extension and contraction enable a larger amount of tightening. Accordingly, the boot fixing band 2A can be applied to a wider range of diameters of the boot 1. That is, one type of boot fixing band 2A can be used for a plurality of types of boots in which the diameter at the band-attached portion is slightly different from each other.

Also, by forming the pattern 25 as shown in FIG. 1 on the surface of each component, the boot fixing band 2A becomes excellent in terms of production management. That is, various types of patterns can be used as the pattern 25, and by associating the patterns of the boot fixing band 2A with respective types of boot 1, each boot fixing band 2A can be apparently distinguished from each other. For example, the automobile manufacturer or the car model, or the part of an automobile for which each boot fixing band 2A is used can be easily recognized. Accordingly, production management and stock management can be easily performed.

Also, the weight of the boot fixing band 2A itself can be advantageously reduced. That is, since the pattern 25 on the boot fixing band 2A of this embodiment is realized by forming depressions on the plate surface in the thickness direction, and thus the weight is reduced accordingly. Further, the pattern 25 serves as a slip stopper, so that the lever plate 23 can be easily tilted due to the proper roughness.

Further, in this embodiment, since the pattern 25 is formed on both surfaces of the ring portion 21 of the band main body 20, the pattern 25 on the rear surface of the ring portion 21 of the band main body 20 (the portion to be in contact with the outer periphery 1a or 1b of the boot 1) serves as a slip stopper when the band is attached around the boot 1. Therefore, the band is resistant to loosening even in long use under severe working conditions.

Desirably, the depth of grooves or the fineness of the pattern 25 should be set depending on the material of the boot 1 for which the boot fixing band 2A is used or on the part of an automobile where the boot 1 is used. This is because the frictional resistance and the electric resistance during spot welding vary depending on the depth of grooves or the fineness of the pattern 25. Therefore, the depth of grooves and the fineness of the pattern 25 should be optimally set in accordance with the material of the boot 1 and the working condition of the boot 1.

Specifically, for the boot 1 comprising a relatively hard plastic material, a fine pattern 25 of relatively shallow grooves (2 μm to 10 μm) should be formed on the boot fixing band 2A, so that a favorable result can be obtained. On the other hand, for the boot 1 comprising a relatively soft plastic material, such as urethane series, a relatively rough pattern 25 of relatively deep grooves (5 μm to 20 μm) should be formed on the boot fixing band 2A, so that a favorable result can be obtained.

The boot 1 comprising a plastic material is often used in the interior of an automobile or other less exposed part, at a joint which rotates at low speed. Therefore, the band is relatively loosely attached.

In contrast to the boot 1 comprising a plastic material, the boot 1 comprising a rubber material is often exposed and is used under severe working conditions, such as at an axle rotating at high speed. Therefore, the boot fixing band 2A used for this type of boot 1 is required to have a higher quality. In the boot fixing band 2A used in this boot 1, a twilled pattern of deep grooves (8 μm to 25 μm) is suitably used as the pattern 25, so that a favorable result can be obtained.

Incidentally, when higher-load tightening is required, a hairline pattern is used as the pattern 25, in which the depth of grooves is 2% to 6% of the plate thickness of the band main body 20, so that a favorable result can be obtained.

In the boot fixing band 2A of this embodiment in a state where the lever plate 23 is laid and is fixed by the lever-plate fixing member 24, the amount of external protuberances is so small that the entire appearance of the band is almost the same as that of the ring portion 21 of the band main body 20. In particular, when the boot fixing band 2A is used for tightening the boot 1 at a joint of an axle of an automobile, the amount of external protuberances of the boot fixing band 2A must be small so as to minimize air resistance because the boot 1 rotates at high speed with the axle.

As described above, in the boot fixing band 2A of this embodiment, the production efficiency can be significantly increased (by about 30%) compared to the known boot fixing band 2 of this type, and the tightening stability on the boot 1 can be increased more than twice. Accordingly, the resistance to severe working conditions can be significantly improved.

Further, in this boot fixing band 2A, spot-welding failure can be effectively prevented, so that only a random inspection is required, although a 100% inspection was conventionally required. Also, weight reduction can be achieved, which contributes to reduction of the total weight of an automobile when the bands are used in several tens of parts in the automobile.

The pattern 25 may be formed after producing each component forming the boot fixing band 2A: the band main body 20, the lever plate 23, and the lever-plate fixing member 24. However, considering the production efficiency, it is preferable to form the pattern 25 on a plate before producing a completed component. Hereinafter, a process of forming the pattern will be described.

The pattern 25 can be easily formed in a rolling process in a plate producing process for producing each component of the boot fixing band 2A, such as the band main body 20, the lever plate 23, and the lever-plate fixing member 24.

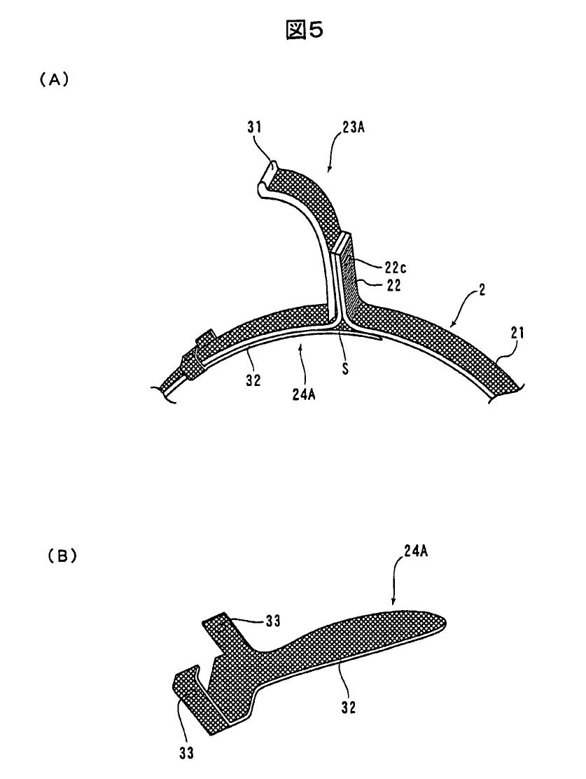

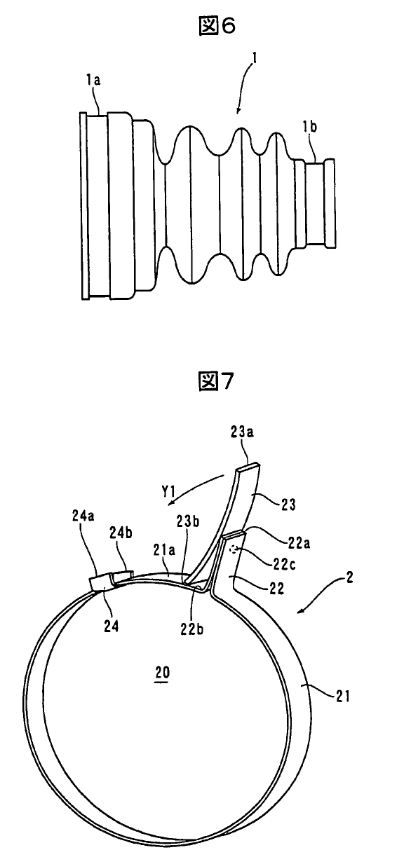

FIG. 4 schematically shows the rolling process, in which a rough rolling step and the subsequent steps are shown. As shown in FIG. 4, the steps subsequent to the rough rolling step 31 include: an annealing step 32; an intermediate rolling step 33; an annealing step 34; a finishing rolling step 35; a tension/annealing step 36; and an inspection/test step 37.

After the rolling process shown in FIG. 4, a cutting process of cutting the rolled material into a predetermined shape and dimension and so on are performed in order to produce the band main body 20, the lever plate 23, and the lever-plate fixing member 24. However, these processes are the same as those performed in the conventional process of producing a boot fixing band, and thus are not shown in the figure and the corresponding description will be omitted.

In a series of steps in the rolling process shown in FIG. 4, a pattern is formed on a metallic (stainless) plate 38, which is the material for producing the components of the boot fixing band 2A, in the intermediate rolling step 33 or the finishing rolling step 35, depending on the depth of grooves of the pattern 25 to be formed.

Among the components of the boot fixing band 2A, the band main body 20 and the lever-plate fixing member 24 are made of plates having the same thickness, and thus the same type of plate 38 can be used. However, the lever plate 23 has a different thickness, and thus another type of plate 38 for the lever plate is used to perform the rolling process shown in FIG. 4.

As described above, the depth of grooves of the pattern 25 formed in this rolling process varies depending on the material of the boot 1 for which the boot fixing band 2A is used (e.g., whether a plastic material or a rubber material), that is, depending on the used part of an automobile. In this case, the pattern 25 of deep grooves is formed in the intermediate rolling step 33, whereas the pattern 25 of shallow grooves is formed in the finishing rolling step 35.

In this way, in order to form a suitable type of pattern 25 on the plate 38, which is used as the material of the components of the boot fixing band 2A, in the intermediate rolling step 33 or the finishing rolling step 35, a pattern of projections to be formed is formed on the surface of at least one of reduction rolls used in the intermediate rolling step 33 (at least one of a pair of reduction rolls 39a and 39b sandwiching the plate 38 from both sides) and reduction rolls used in the finishing rolling step 35 (at least one of a pair of reduction rolls 40a and 40b sandwiching the plate from both sides). By forming the pattern of projections, that is, the pattern of projections and depressions, on the reduction roll, the pattern 25 can be formed on the plate 38. In the boot fixing band 2A of this embodiment, the pair of reduction rolls 40a and 40b, each having a pattern of projections and depressions, are used.

In this way, when the plate 38 is rolled, the pattern formed on the pair of reduction rolls 39a and 39b for the intermediate rolling step 33 or the pair of reduction rolls 40a and 40b for the finishing rolling step 35 is formed as the pattern 25 of depressions on both surfaces or one of the surfaces of the plate 38.

Alternatively, many reduction rolls of various types of patterns may be prepared for the pair of reduction rolls 39a and 39b for the intermediate rolling step 33 and the pair of reduction rolls 40a and 40b for the finishing rolling step 35. Accordingly, a desired type of reduction rolls can be arbitrarily selected and used according to a required pattern.

For example, when boot fixing bands 2A having the pattern 25 of deep grooves are to be produced for boots supplied to an automobile manufacturer, reduction rolls capable of forming the pattern 25 which is associated with the automobile manufacturer and which has grooves of optimal depth are selected. In this case, since the depth of the grooves is deep, the pattern is formed in the intermediate rolling step 33. Therefore, reduction rolls having the corresponding pattern and grooves are selected as the reduction rolls 39a and 39b for the intermediate rolling step 33, the selected rolls are attached for the intermediate rolling step 33, and then the rolling step is performed.

In this way, the pattern 25 of various shapes and depths of grooves can be formed. That is, the pattern 25 of desired type and depth of grooves can be formed on the boot fixing band 2A in accordance with the intended purpose or the type of boots. Accordingly, the range of yield strength can be set and a desired tightening strength can be obtained. Also, since each type of the pattern 25 can be used as identification information, the patterns can be appropriately classified by manufacturer to which the products are supplied or by used part, and thus production management can be conveniently performed.

Each pair of reduction rolls should have the same pattern in the pair of reduction rolls 39a and 39b for the intermediate rolling step 33 and the pair of reduction rolls 40a and 40b for the finishing rolling step 35. For example, when a pattern is to be formed on both surfaces of the plate 38 in the intermediate rolling step 33, the pair of reduction rolls 39a and 39b should have the same pattern. Likewise, when a pattern is to be formed on both surfaces of the plate 38 in the finishing rolling step 35, the pair of reduction rolls 40a and 40b should have the same pattern. However, the front and rear surfaces of the plate 38 may have different patterns. In that case, in the intermediate rolling step 33, for example, the pattern on the upper reduction roll 39a is made different from that on the lower reduction roll 39b.

With this method, the front and rear surfaces of the plate 38 are allowed to have different patterns 25. In this way, by forming different patterns 25 on the respective front and rear surfaces of the plate 38, and by producing the band main body 20 by using this plate 38, the difference between the patterns 25 on the front and rear surfaces of the band main body 20 manifests itself as the difference in the above-described yield strength. Therefore, a tightening strength which is different from that in the case where the both front and rear surfaces have the same pattern 25 may be obtained, and thus the boot fixing band 2A having a wider variety of tightening abilities can be obtained.

The above-described embodiment is a preferred embodiment of the present invention. However, the present invention is not limited to the above-described embodiment, but various modifications can be realized without deviating from the scope of the present invention. For example, the boot fixing band with no lever plate disclosed in Japanese Patent Application Laid-open No. Hei 11-218282 can be used as a tightening band. Alternatively, the tightening band can be used in other applications than fixing a boot. That is, the present invention can be widely applied to any tightening band which includes a band main body including a ring portion formed by bending a metallic elongated band plate, a predetermined length of both end portions of the metallic elongated band plate being overlapped, and which applies a tightening force to a member to be tightened by reducing the diameter of the ring portion of the band main body.

Alternatively, as shown in FIG. 5, a lever plate 23A having a shape easy to tilt may be used instead of the lever plate 23. Also, a lever-plate fixing member 24A which is longer than the lever-plate fixing member 24 may be used so as to eliminate the non-contact portion S shown in FIG. 8 (B), which does not contact the boot 1. The lever plate 23A shown in FIG. 5 has a projection 31, which is projected in the thickness direction and which serves as a finger stopper, at the upper end thereof. The lever-plate fixing member 24A has a long tongue piece 32 disposed so as to cover the non-contact portion S shown in FIG. 8 (B). Also, embossed dowels 33, which are protruded inwardly and which are used for easily pressing the lever plate 23A, are provided at the projected portions 24a and 24b, respectively. The projected portions 24a and 24b are not placed while symmetrically facing each other, but they are displaced from each other in the circumference direction, so that they are not overlapped when being folded.

The pattern 25 on the band main body 20 is formed in the following manner. On the band protrusion 22, a twilled pattern consisting of a plurality of parallel lines aligned in the width direction is formed as the pattern 25. On the ring portion 21, a rhombic meshed pattern (each cell is rhombic) consisting of straight lines crossing in slanting directions is formed as the pattern 25. On the lever plate 23A and the lever-plate fixing member 24A, a rhombic meshed pattern is formed as the pattern 25. Although one type of pattern 25 is formed on the plate surface in the embodiment shown in FIG. 1 and two types of patterns 25 are formed in FIG. 5, three or more types of patterns may be formed on one tightening band. In that case, it is preferable that one type of pattern 25 is formed on each member, but two or more types of patterns 25 may be formed on each member.

In the above-described embodiment, when the pattern 25 is formed in the intermediate rolling step 33 or the finishing rolling step 35, the pattern 25 is formed on both surfaces of the plate 38 by using the pair of reduction rolls 39a and 39b and 40a and 40b, respectively. However, the pattern 25 may be formed on only one of the surfaces: the front surface or the rear surface of the plate 38. Further, in the rolling steps 33 and 35 for each member, reduction rolls for forming a pattern may be used only in a step of rolling a predetermined member or a plurality of predetermined members. Further, a pattern may be formed in both the intermediate rolling step 33 and the finishing rolling step 35, so as to form the pattern 25 of different depths, lines of different thicknesses, or lines of different spacing. For example, a pattern of deep and thick straight lines extending in parallel in one direction with large spacing may be formed in the intermediate rolling step 33, and a pattern of shallow and thin straight lines diagonally crossing the straight lines with small spacing may be formed in the finishing rolling step 35.

The pattern of projections and depressions formed over the entire circumference of at least one of the pair of reduction rolls 39a and 39b and/or at least one of the pair of reduction rolls 40a and 40b, which are used in the intermediate rolling step 33 or the finishing rolling step 35, may include different patterns. For example, three types of patterns may be formed on the surface of the reduction roll in 120-degree intervals, six types of patterns may be formed on the surface of the reduction roll in 60-degree intervals, or two types of patterns may be alternately formed in 60-degree intervals.

Alternatively, the pattern may be formed on only one of the surfaces of the plate 38, so that each of the band main body 20, the lever plate 23, and the lever-plate fixing member 24 has a pattern on only one of the surfaces. Even if such a member is used, the reliability of spot welding can be increased and the positioning for welding the lever plate 23 to the band protrusion 22 can be simplified compared to a member having no pattern. Also, the yield strength increases and the range of extension and contraction effectively extends. In particular, by forming the band main body 20 so that the pattern is positioned on its inner periphery, the rough portion contacts the boot 1, and thus the pattern serves as a slip stopper.

Alternatively, the pattern 25 may be formed on the surface of at least one of the band main body 20, the lever plate 23, and the lever-plate fixing member 24 by replacing the reduction rolls 39a, 39b, 40a, and 40b or by forming a pattern after the band main body 20, the lever plate 23, and the lever-plate fixing member 24 have been produced. In that case, too, the pattern 25 may be formed on only one of the surfaces or both surfaces of the plate. Further, although the lever plate 23 is originally arc-shaped in the above-described embodiment, the lever plate 23 may be formed in a flat-shape and it may be deformed into an arc-shape while being laid or after being laid.

Extremely speaking, the pattern 25 may be formed on only a welded portion, by placing high priority on the reliability of welding. In this case, even if a pattern is formed on only one of welded portions, the reliability of welding preferably increases at that portion. When the pattern 25 is to be formed on only a welded portion, the pattern 25 may be formed on only one of the surfaces of a plate, not on both opposed surfaces thereof. Further, when each member is to be fixed, spot welding need not be used at every portion. Instead, spot welding is adopted in only one of the portions, and other fixing methods such as laser welding, beam welding, bonding with adhesive, and ultrasonic bonding may be adopted in the other portions. Alternatively, all the portions to be welded may be fixed by using a method other than spot welding.

The boot fixing band 2A according to the above-described embodiment is intended to be used for the boot 1 in an automobile. However, the boot fixing band 2A can be widely used as a tightening band which is to be attached around the periphery of a member having a circular cross-section so as to apply a tightening force thereto. For example, the boot fixing band 2A can be used for tightening a water pipe portion or gas pipe portion, or tightening a cover for a joint in a machine tool.

### INDUSTRIAL APPLICABILITY

According to the present invention, a tightening band which realizes an improved workability of attachment, proper tightening strength, wider applicable range of members to be tightened, and a stable tightening strength lasting for a long time can be obtained. As a result, the tightening band can be preferably used for attaching a boot of an automobile, and also can be used for tightening other members.

1. A tightening band comprising:
a band main body including a ring portion formed by bending a metallic elongated band plate and a band protrusion formed by overlapping and welding a predetermined length of both end portions of the metallic elongated band plate such that the both end portions face each other;
a lever plate whose top side is protruded outward from the top of the band protrusion and which is fixed to the band protrusion by being welded thereto such that the end side of the lever plate is in contact with the outer periphery of the ring portion of the band main body; and
a lever-plate fixing member which is fixed to the band main body by being welded thereto so as to fix the top portion of the lever plate to the band main body,
the diameter of the ring portion of the band main body being reduced by tilting the lever plate until the surface of the lever plate is brought into contact with the outer periphery of the ring portion of the band main body while the end side of the lever plate serving as the fulcrum, so as to apply a tightening force to a member to be tightened,
wherein a pattern of projections and depressions is formed on the surface of each of the band main body, the lever plate, and the lever-plate fixing member.

2. A tightening band comprising:
a band main body including a ring portion formed by bending a metallic elongated band plate and a band protrusion formed by overlapping and fixing a predetermined length of both end portions of the metallic elongated band plate such that the both end portions face each other;
a lever plate whose top side is protruded outward from the top of the band protrusion and which is fixed to the band protrusion such that the end side of the lever plate is in contact with the outer periphery of the ring portion of the band main body; and
a lever-plate fixing member for fixing the top portion of the lever plate to the band main body,
the diameter of the ring portion of the band main body being reduced by tilting the lever plate until the surface of the lever plate is brought into contact with the outer periphery of the ring portion of the band main body while the end side of the lever plate serving as the fulcrum, so as to apply a tightening force to a member to be tightened,
wherein a pattern of projections and depressions is formed on at least the inner periphery of the band main body and the surface of the lever plate which contacts the band main body.

3. (canceled)

4. A tightening band according to claim 1, wherein, when fixing for forming the band protrusion, fixing between the band protrusion and the lever plate, or fixing between the band main body and the lever-plate fixing member is performed by welding, the pattern of projections and depressions is formed at least so that each member to be welded contacts each other at many points inside the diameter of a spot to be welded.

5. A tightening band according to claim 1, wherein the pattern of projections and depressions is formed by providing a plurality of linear depressions in a mesh pattern on the surface.

6. A tightening band according to claim 5, wherein the depth of each depression is 2 μm to 30 μm.

7. A tightening band according to claim 1, wherein the pattern formed on the surface comprises a plurality of types of patterns, and each type of pattern represents identification information of a boot fixing band on which the pattern of the type is formed.

8. A tightening band according to claim 1, wherein the pattern formed on the surface comprises a plurality of types of patterns in one tightening band.

9. A tightening band according to claim 1, wherein the member to be tightened is a protective cover for protecting a joint of a rotary shaft of an automobile.

10. A method for producing a tightening band comprising:
a band main body including a ring portion formed by bending a metallic elongated band plate and a band protrusion formed by overlapping and fixing by welding a predetermined length of both end portions of the metallic elongated band plate such that the both end portions face each other;
a lever plate whose top side is protruded outward from the top of the band protrusion and which is fixed to the band protrusion by being welded thereto at the same time when the band protrusion is formed such that the end side of the lever plate is in contact with the outer periphery of the ring portion of the band main body; and
a lever-plate fixing member for fixing the top portion of the lever plate to the band main body by welding,
the diameter of the ring portion of the band main body being reduced by tilting the lever plate until the surface of the lever plate is brought into contact with the outer periphery of the ring portion of the band main body while the end side of the lever plate serving as the fulcrum, so as to apply a tightening force to a member to be tightened,
the method comprising:
forming a pattern of projections and depressions, the difference between the projections and depressions being 2 μm to 30 μm, on reduction rolls used in at least one of rolling steps of rolling each metallic plate as a base material of the band main body, the lever plate, and the lever-plate fixing member;
forming the pattern of projections and depressions having a depth of 2 μm to 30 μm on at least one of the surfaces of the metallic plate by passing the metallic plate through the reduction rolls; and
cutting the rolled base material into plates for the band main body, the lever plate, and the lever-plate fixing member, so as to produce the tightening band by using the cut plates with the pattern for the band main body, the lever plate, and the lever-plate fixing member.

11. (canceled)

12. A method for producing a tightening band according to claim 10, wherein the reduction rolls comprise a plurality of types of reduction rolls so that the pattern differs from one reduction roll to another, and any reduction rolls can be arbitrarily selected from among the reduction rolls and used in the rolling step.

13. A tightening band according to claim 2, wherein, when fixing for forming the band protrusion, fixing between the band protrusion and the lever plate, or fixing between the band main body and the lever-plate fixing member is performed by welding, the pattern of projections and depressions is formed at least so that each member to be welded contacts each other at many points inside the diameter of a spot to be welded.

14. A tightening band according to claim 2, wherein the pattern of projections and depressions is formed by providing a plurality of linear depressions in a mesh pattern on the surface.

15. A tightening band according to claim 14, wherein the depth of each depression is 2 μm to 30 μm.

16. A tightening band according to claim 2, wherein the pattern formed on the surface comprises a plurality of types of patterns, and each type of pattern represents identification information of a boot fixing band on which the pattern of the type is formed.

17. A tightening band according to claim 2, wherein the pattern formed on the surface comprises a plurality of types of patterns in one tightening band.

18. A tightening band according to claim 2, wherein the member to be tightened is a protective cover for protecting a joint of a rotary shaft of an automobile.
